(19) United States
(12) Patent Application Publication
(10) Pub. No.: US 2026/0061299 A1
(43) Pub. Date: Mar. 5, 2026

(54) PLAYING SURFACE WITH IMPREGNATED SUBSTANCE

(71) Applicant: Valley-Dynamo LP, Richland Hills, TX (US)

(72) Inventors: Kelye Stites, Colleyville, TX (US); Martin Bohn, North Richland Hills, TX (US)

(21) Appl. No.: 19/309,768

(22) Filed: Aug. 26, 2025

Related U.S. Application Data
(60) Provisional application No. 63/688,100, filed on Aug. 28, 2024.

(51) Int. Cl. A63F 7/00; A63F 7/30; C09D 7/65; C09D 15/00; C09D 163/00

(52) U.S. Cl. CPC A63F 7/0005; A63F 7/30; C09D 7/65; C09D 15/00; C09D 163/00

(57) ABSTRACT

The present disclosure is directed to a playing surface for a shuffleboard including an impregnated substance. The playing surface may include a base layer, a first finish layer, and a second finish layer. In some embodiments, the base layer may be made of wood and the first and second finish layers may be formed from a polymer or epoxy. The first finish layer may be produced by pouring a first layer of epoxy onto the base layer, and the second finish layer may be produced by pouring a second layer of epoxy onto the first finish layer at least 24 hours after the pouring of the first layer of epoxy. The second finish layer may be impregnated with a particulate substance after a predetermined amount of time has passed since the pouring of the second layer of epoxy.

### CROSS-REFERENCE TO RELATED APPLICATIONS

This application claims priority under 35 U.S.C. § 119 to U.S. Provisional Patent Application No. 63/688,100, filed Aug. 28, 2024, the entirety of which is hereby incorporated by reference.

### FIELD OF INVENTION

The present disclosure relates to a shuffleboard playing surface, in particular, a shuffleboard playing surface with an impregnated substance.

### BACKGROUND OF INVENTION

Shuffleboard is a popular game that involves a long narrow surface (e.g., a playfield) with two opposing ends. Players compete by sliding pucks from one end of the playfield to the other, aiming to land each puck in a “scoring zone” at the opponent's end. Thus, the shuffleboard playfield is typically designed to be smooth and level such that pucks can glide easily from end to end with the intended trajectory and speed, with the aid of powders using varying ingredients. Users commonly treat the finished playfield with sand or other substances during play to supplement the construction of the shuffleboard itself and further reduce friction between the puck and the playfield.

### SUMMARY OF INVENTION

The present disclosure is directed to a shuffleboard with a playing surface including an impregnated substance. The shuffleboard may include a base supported by one or more legs and a playfield surrounded by a gutter and a cradle. The playfield may include a base layer, a first finish layer, and a second finish layer. In some embodiments, the base layer may be formed from wood, the first finish layer may be formed from a polymer or epoxy, and the second finish layer may be formed from a polymer or epoxy impregnated with a particulate substance. The particulate substance may be provided in the form of particles of silica, alumina, or any other suitable material. In some embodiments, the first finish layer and the second finish layer may be produced using the same epoxy. The second finish layer may reduce a need to add sand, powder, or other substances to the playfield during play.

These and other aspects and advantages of the present invention will become apparent to those skilled in the art after considering the following detailed description in connection with the accompanying drawings.

### BRIEF DESCRIPTION OF THE DRAWINGS

FIG. 1 is a perspective view of a shuffleboard.

FIG. 2 is an enlarged perspective view of a portion of a playfield of the shuffleboard of FIG. 1 in a first stage of construction.

FIG. 3 is an enlarged perspective view of the portion of FIG. 2 in a second stage of construction.

FIG. 4 is an enlarged perspective view of the portion of FIG. 2 in a third stage of operation.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The following description refers to the drawing figures, in which like reference numerals refer to like parts throughout. For purposes of clarity in illustrating the exemplary embodiments described herein, proportional relationships of the elements have not necessarily been maintained in the drawing figures.

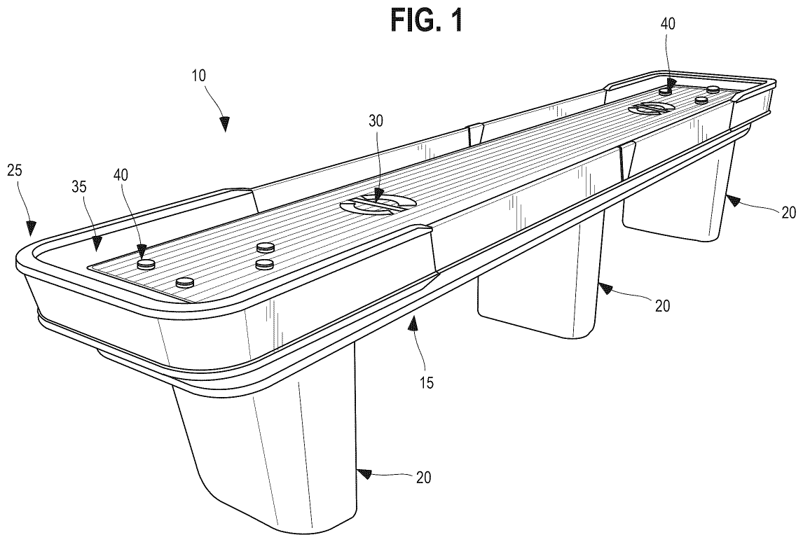

Referring first to FIG. 1, a shuffleboard 10 may include a base 15 supported by one or more legs 20. An outer wall or cradle 25 may be positioned atop and supported by the base 15, and a playfield 30 may be positioned within the cradle 25. A gutter 35 may be positioned between the playfield 30 and the cradle 25 and may substantially surround the playfield 30. The shuffleboard 10 may include one or more pucks 40 configured to slide across the playfield 30 when the shuffleboard 10 is in use.

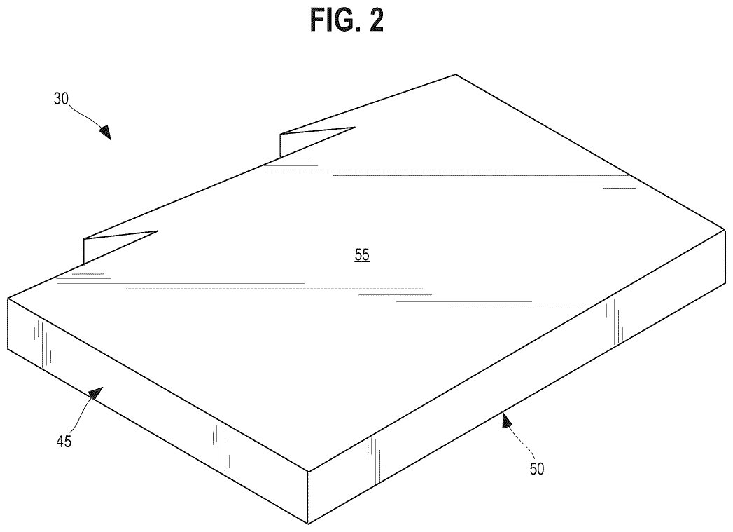

In some embodiments, the playfield 30 may include multiple layers and may be formed from multiple materials. For example, the playfield 30 may include one or more layers of wood and one or more layers of polymer. Turning to FIGS. 2-4, an enlarged portion of the playfield 30 is depicted through multiple stages of construction.

FIG. 2 depicts a first stage of construction of the playfield 30 where a base layer 45 of the playfield 30 is provided. In some embodiments, the base layer 45 may be made of wood (e.g. a hardwood such as maple). In other embodiments, the base layer 45 may be formed from another suitable material. The base layer 45 may be provided in the form of a substantially rectilinear plank or body including a substantially planar lower surface 50 and a substantially planar upper surface 55 opposing the lower surface 50. The lower surface 50 may be positioned adjacent to the base 15 when the shuffleboard 10 is assembled.

The base layer 45 may have a thickness between about 1 inch and about 3 inches. For example, in some embodiments, the base layer 45 may have a thickness of at least about 1 inch, at least about 1.5 inches, at least about 2 inches, at least about 2.5 inches, or at least about 3 inches. In some embodiments, the base layer 45 may have a thickness of about 2.25 inches. In other embodiments, the base layer 45 may be provided with any suitable thickness.

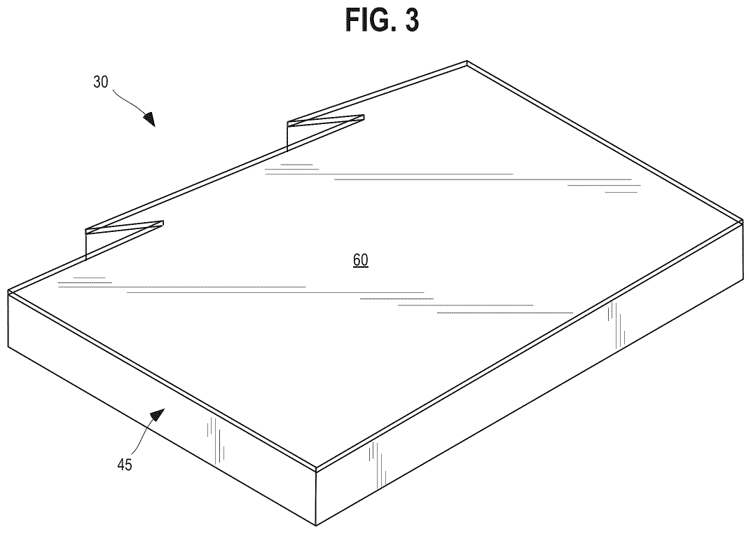

Turning to FIG. 3, a second stage of construction of the playfield 30 may include applying a first finish layer 60 to the base layer 45 (e.g., to the upper surface 55 of the base layer 45). In some embodiments, the first finish layer 60 is made of a polymer or epoxy. For example, the second stage of construction may include applying a first pour of an epoxy (e.g., an epoxy resin or a mixture of an epoxy resin and a hardening agent) to the base layer 45. The second stage of construction may include the steps of pouring the epoxy, leveling the epoxy, and allowing the epoxy to rest (e.g., harden). Thus, the first pour of epoxy may cure or harden such that the first finish layer 60 is made of a thermoset or a thermosetting polymer at the end of the second stage of construction. In some embodiments, the epoxy may rest for a minimum of 24 hours such that the epoxy may cure and harden before the third stage of construction begins. In some embodiments, first finish layer 60 may be substantially smooth, but may be wavy to a certain extent.

The first finish layer 60 may have a thickness between about 3/32 inches and about ⅛ inches. For example, in some embodiments, the first finish layer 60 may have a thickness of at least about 3/32 inches. In some embodiments, the first finish layer 60 may have a thickness of up to about ⅛ inches.

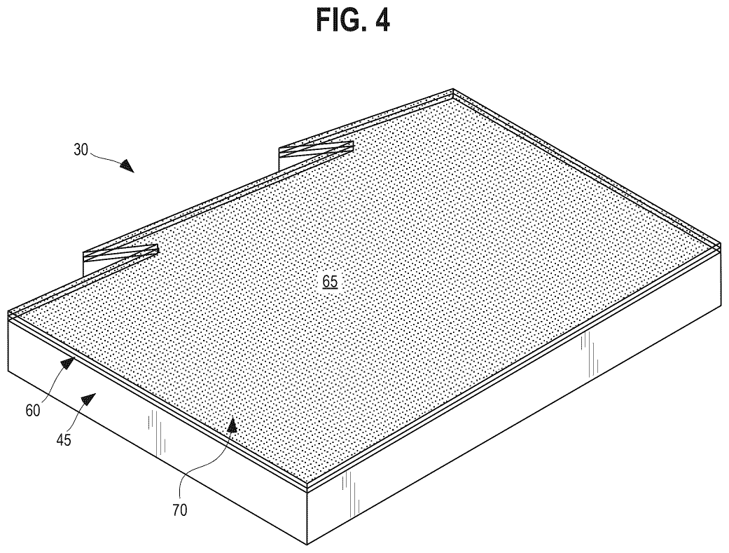

Turning to FIG. 4, a third stage of construction of the playfield 30 may include applying a second finish layer 65 to the first finish layer 60 (e.g., such that the first finish layer 60 is positioned between the base layer 45 and the second finish layer 65). Like the first finish layer 60, the second finish layer 65 may be made of a polymer or epoxy. Thus, the third stage of construction may include applying a second pour of an epoxy to the first finish layer 60. In some embodiments, the second finish layer 65 is made from the same epoxy as the first finish layer 60. However, in other embodiments, the first and second finish layers 60, 65 may be formed from different materials.

The first finish layer 60 (e.g., the first pour) and the second finish layer 65 (e.g., the second pour) may be applied a minimum of 24 hours apart. The third stage of construction may include pouring the epoxy, leveling the epoxy, allowing the epoxy to rest (e.g., harden), and impregnating the epoxy before it fully hardens. The second pour may result in a substantially smooth and level playing surface of the playfield 30. For example, the exposed or upper surface of the second finish layer 65 may be substantially free from deformations or deviations from a level planar surface that could interfere with the intended motion of the puck 40.

Unlike the first finish layer 60, the second finish layer 65 may be impregnated with a particulate substance 70. The particulate substance 70 may be provided to improve the smoothness of or reduce an amount of friction associated with the second finish layer 65, thereby improving the ability of the puck 40 to slide across the playfield 30. For example, the particulate substance 70 may include particles of one or more substances such as silica, alumina, polytetrafluoroethylene (PTFE), graphite, ceramic, and/or other materials. In some embodiments, the particulate substance 70 may be provided in the form of silicone beads. In other embodiments, the particulate substance 70 may include particles or beads of any suitable material or any combination of suitable materials. The inclusion of the second finish layer 65 impregnated with the particulate substance 70 may reduce a need to add sand, powder, or other materials to the playfield 30 during play.

In some embodiments, a predetermined amount of time may be permitted to pass between pouring the second layer of epoxy and impregnating the second finish layer 65 with the particulate substance 70. For example, in some embodiments, the particulate substance 70 may be added to the second layer of epoxy after the second layer of epoxy has been allowed to rest for at least about one hour. In other embodiments, the particulate substance 70 may be added to the second finish layer 65 after at least about two hours, at least about four hours, at least about six hours, or another predetermined amount of time has passed since the second pour of epoxy. Thus, the particulate substance 70 may be added to a partially hardened epoxy of the second finish layer 65, resulting in a “stipple”type finish of the second finish layer 65 and the playfield 30.

The second finish layer 65 may have a thickness between about 3/32 inches and about ⅛ inches. For example, in some embodiments, the second finish layer 65 may have a thickness of at least about 3/32 inches. In some embodiments, the second finish layer 65 may have a thickness of up to about ⅛ inches.

In some embodiments, a crystal clear epoxy resin (i.e., an epoxy resin that cures to a transparent or glass-like finish) may be used in the first pour and/or the second pour of epoxy to produce the first finish layer 60 and/or the second finish layer 65, respectively. In this way, the first finish layer 60 and/or the second finish layer 65 may be translucent or transparent when cured such that the natural color, grain, or other characteristic of the base layer 45 can be seen through the first finish layer 60 and/or the second finish layer 65.

As is evident from the foregoing description, certain aspects of the present disclosure are not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations and other uses in applications which do not depart from the spirit and scope of the present disclosure are deemed to be covered by the invention which is limited only by the claims which follow.

What is claimed is:

1. A playing surface for a shuffleboard, comprising:
a base layer;
a first finish layer positioned atop the base layer; and
a second finish layer positioned atop the first finish layer,
wherein the second finish layer is impregnated with a particulate substance.

2. The playing surface of claim 1, wherein the base layer is made of wood.

3. The playing surface of claim 1, wherein the first finish layer comprises a polymer or epoxy.

4. The playing surface of claim 1, wherein the first finish layer has a thickness between 3/32 inches and ⅛ inches.

5. The playing surface of claim 1, wherein the second finish layer comprises a polymer or epoxy.

6. The playing surface of claim 1, wherein the second finish layer has a thickness between 3/32 inches and ⅛ inches.

7. The playing surface of claim 1, wherein the first and second finish layers are each formed from the same thermoset polymer.

8. The playing surface of claim 1, wherein the second finish layer is impregnated with the particulate substance before the second finish layer is finished hardening.

9. The playing surface of claim 8, wherein the particulate substance includes one or more materials selected from: silica, alumina, polytetrafluoroethylene, graphite, and ceramic.

10. The playing surface of claim 8, wherein the particulate substance comprises silicone beads.

11. A method of producing a playing surface for a shuffleboard, comprising:
providing a base layer made of wood;
applying a first pour of epoxy to the base layer;
curing the first pour of epoxy to form a first finish layer by allowing the first pour of epoxy to rest for a minimum of 24 hours;
applying a second pour of epoxy to the first finish layer;
impregnating the second pour of epoxy with a particulate substance; and
curing the second pour of epoxy to form a second finish layer.

12. The method of claim 11, wherein the steps of applying a first pour of epoxy and applying a second pour of epoxy each further include the steps of:
pouring the epoxy;
leveling the epoxy; and
allowing the epoxy to rest and harden.

13. The method of claim 11, wherein the second pour of epoxy is impregnated with the particulate substance before the second pour of epoxy has fully hardened.

14. The method of claim 13, wherein at least an hour is permitted to pass between applying the second pour of epoxy to the first finish layer and impregnating the second pour of epoxy with the particulate substance.

15. The method of claim 11, wherein the particulate substance includes one or more materials selected from: silica, alumina, polytetrafluoroethylene, graphite, and ceramic.

16. The method of claim 11, wherein the particulate substance comprises silicone beads.

17. The method of claim 11, wherein a crystal clear epoxy resin is used for applying the first pour of epoxy and applying the second pour of epoxy.

18. The method of claim 11, wherein the first finish layer and the second finish layer each have a thickness between 3/32 inches and ⅛ inches.

19. A shuffleboard comprising:
a base supported by one or more legs;
a cradle supported atop the base;
a playfield positioned within the cradle, the playfield comprising:
a base layer formed from wood;
a first finish layer formed from an epoxy or polymer; and
a second finish layer formed from an epoxy or polymer, wherein the second finish layer is impregnated with a particulate substance including one or more materials selected from: silica, alumina, polytetrafluoroethylene, graphite, and ceramic; and
one or more pucks configured to slide across the playfield.

20. The shuffleboard of claim 19, wherein the second finish layer is formed by pouring a layer of uncured epoxy or polymer, allowing the epoxy or polymer to rest, and impregnating the epoxy or polymer with the particulate substance before the epoxy or polymer has fully cured.
